(19) United States
(12) Patent Application Publication
(10) Pub. No.: US 2019/0287117 A1
(43) Pub. Date: Sep. 19, 2019

(54) AUTOMATED RECEIPT PARSING TO GENERATE RECALL, WARRANTY, AND RETURN NOTIFICATIONS

(71) Applicant: INTERNATIONAL BUSINESS MACHINES CORPORATION, ARMONK, NY (US)

(72) Inventors: Nicholas G. Danyluk, Long Island City, NY (US); Eli M. Dow, Wappingers Falls, NY (US); Kavita Sehgal, Poughkeepsie, NY (US); Diane M. Stamboni, Poughkeepsie, NY (US); Sneha M. Varghese, Fishkill, NY (US); John S. Werner, Fishkill, NY (US); Sarah Wu, Kingston, NY (US)

(21) Appl. No.: 15/925,185

(22) Filed: Mar. 19, 2018

(51) Int. Cl. G06Q 30/00

(52) U.S. Cl. CPC G06Q 30/014; G06Q 30/016; G06Q 30/012

(57) ABSTRACT

A method, computer system, and computer program product for generating purchased product recall, warranty, and return notifications is provided. The embodiment may include identifying a product within a personal product database. The embodiment may also include determining a post-purchase event for the identified product has occurred. The embodiment may further include generating a notification detailing a plurality of information related to the determined post-purchase event. The embodiment may also include transmitting the notification to a user.

### BACKGROUND

The present invention relates, generally, to the field of computing, and more particularly to notification systems.

Notifications may relate to messages transmitted and/or displayed to a user that alerts the user to an item. For example, if a user receives a text message on a mobile device, a notification may be displayed on the home screen of the mobile device to alert the user of the received text message. A notification system may be software and hardware that has the capability of delivering a message to a recipient from a sender. Notification systems may be interrelated with other systems to provide additional capabilities to unrelated entities. For example, a calendar program may have notification system capabilities that allow a notification to be sent to a user as a reminder of an upcoming event.

### SUMMARY

According to one embodiment, a method, computer system, and computer program product for generating purchased product recall, warranty, and return notifications is provided. The embodiment may include identifying a product within a personal product database. The embodiment may also include determining a post-purchase event for the identified product has occurred. The embodiment may further include generating a notification detailing a plurality of information related to the determined post-purchase event. The embodiment may also include transmitting the notification to a user.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a personal product database creation process according to at least one embodiment;

FIG. 3 is an operational flowchart illustrating a recall notification process according to at least one embodiment;

FIG. 4 is an operational flowchart illustrating a return deadline notification process according to at least one embodiment;

FIG. 5 is an operational flowchart illustrating a warranty notification process according to at least one embodiment;

FIG. 6 is a functional block diagram of a product notification platform according to at least one embodiment;

FIG. 7 is a functional block diagram of a locally executed product notification platform according to at least one embodiment;

FIG. 8 is a block diagram of internal and external components of computers and servers depicted in FIG. 1 according to at least one embodiment;

FIG. 9 depicts a cloud computing environment according to an embodiment of the present invention; and

FIG. 10 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to notification systems. The following described exemplary embodiments provide a system, method, and program product to, among other things, notify a user when an event, such as a product return deadline, a warranty expiration, or a product recall, occurs or is upcoming concerning a product previously purchased by the user. Therefore, the present embodiment has the capacity to improve the technical field of notification systems by efficiently allowing users to become aware of upcoming events related to previously purchased products and take appropriate action on a product before an event occurs that would otherwise preclude such action. Similarly, the present embodiment may allow retailers to identify consumers approaching specific deadlines, such as warranty expirations, and extend products, such as warranty extensions, to the identified users.

As previously described, notifications may relate to messages transmitted and/or displayed to a user that alerts the user to an item. For example, if a user receives a text message on a mobile device, a notification may be displayed on the home screen of the mobile device to alert the user of the received text message. A notification system may be software and hardware that has the capability of delivering a message to a recipient from a sender. Notification systems may be interrelated with other systems to provide additional capabilities to unrelated entities. For example, a calendar program may have notification system capabilities that allow a notification to be sent to a user as a reminder of an upcoming event.

Upon purchasing a product, a consumer may experience various time periods (e.g., warranty and return periods) or post-purchase events (e.g., product recalls) related to the purchased product. Receiving notifications about product-related time periods or post purchase events may be difficult for consumers. For example, many recalled products may not be highly publicized, which may leave the onus of checking recall websites or databases on the consumer. In some situations, retailers may notify consumers if a purchased product has been recalled but doing so is not a requirement for all retailers. In another situation, information about a product may arise that would cause concern to a consumer prior to the product being recalled. This information may be unknown to a consumer unless the consumer reads product information or review boards constantly after making the purchase. Similarly, a consumer may wish to return a product but, due to various retailers having different return policies, the consumer may miss the specific return deadline for the store from which the product was purchased. In order to accurately track this various post-purchase time periods, deadlines, and events, an individual must manually track all important dates related to a product, the product's manufacturer, and the retailer from which the product was purchased. As such, it may be advantageous to, among other things, implement a system capable of generating a database of purchased products and notifying the user when a post-purchase event, deadline, or time period is either approaching or has occurred.

According to one embodiment, a user's messaging communication system may be parsed for receipts of purchased products in order to generate a purchased products database. The database may use information from each receipt to send notifications to the user prior to a purchased product passing significant deadlines, such as a return-to-retailer deadline or a warranty expiration deadline. Additionally, retailer websites or other notification systems may be monitored for issuance of recalls for products purchased by the user within the generated database.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to transmit notifications to a user when a previously purchased product has passed or is approaching a post-purchase event, such as a product recall, return deadline, or warranty expiration date.

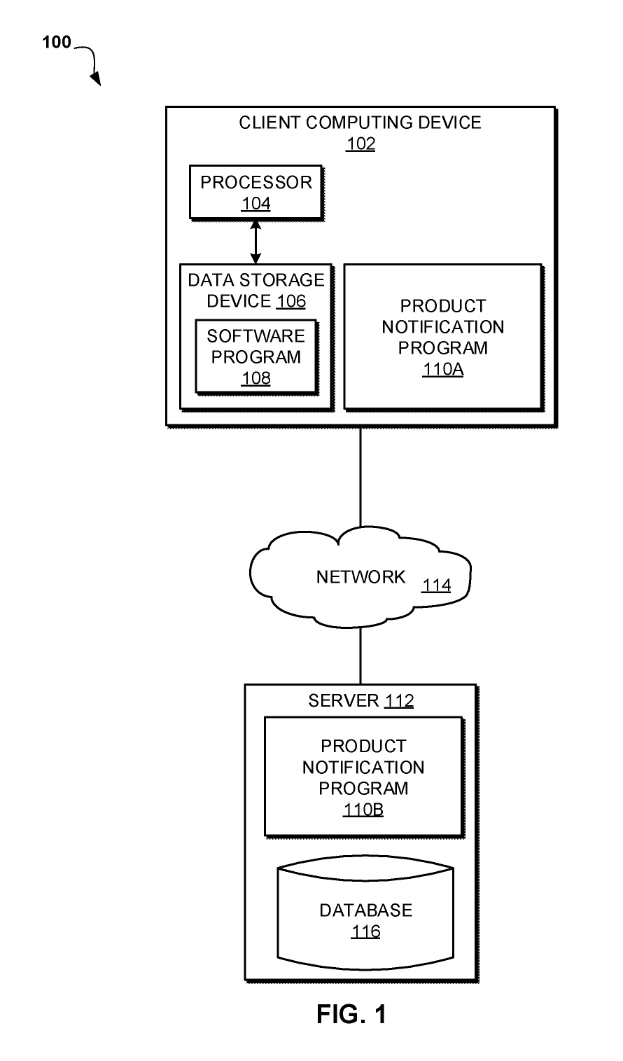

Referring to FIG. 1, an exemplary networked computer environment 100 is depicted, according to at least one embodiment. The networked computer environment 100 may include client computing device 102 and a server 112 interconnected via a communication network 114. According to at least one implementation, the networked computer environment 100 may include a plurality of client computing devices 102 and servers 112 of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

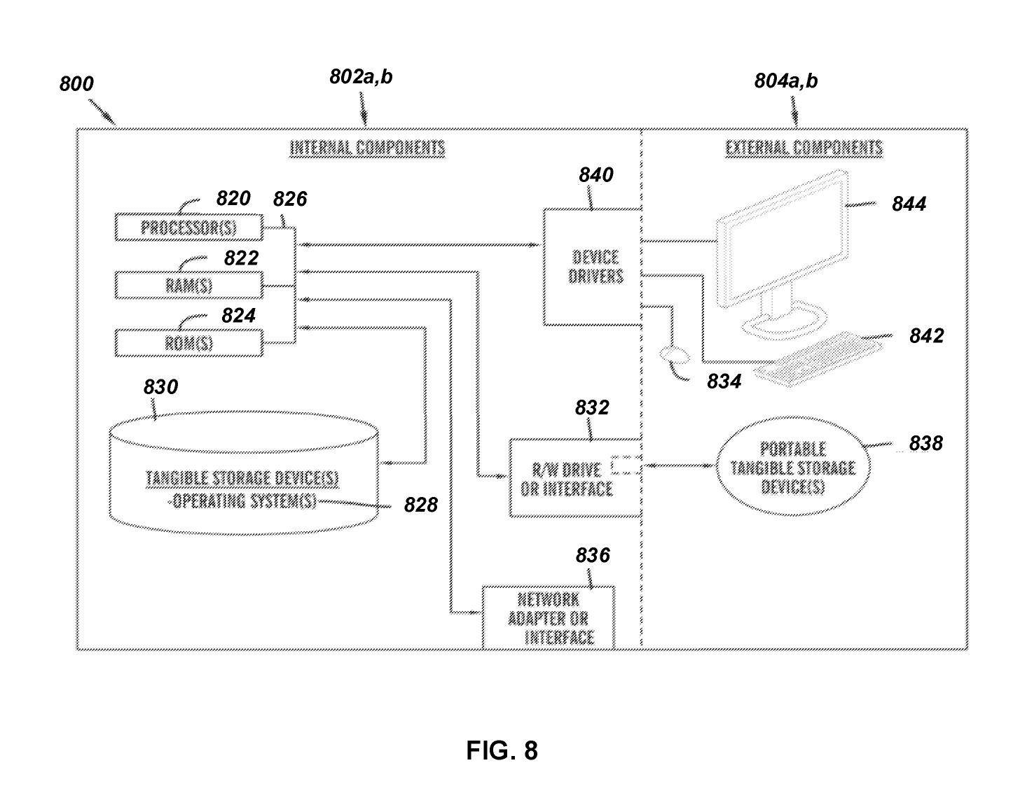

Client computing device 102 may include a processor 104 and a data storage device 106 that is enabled to host and run a software program 108 and a product notification program 110A and communicate with the server 112 via the communication network 114, in accordance with one embodiment of the invention. Client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 8, the client computing device 102 may include internal components 802a and external components 804a, respectively.

The server computer 112 may be a laptop computer, netbook computer, personal computer (PC), a desktop computer, or any programmable electronic device or any network of programmable electronic devices capable of hosting and running a product notification program 110B and a database 116 and communicating with the client computing device 102 via the communication network 114, in accordance with embodiments of the invention. As will be discussed with reference to FIG. 8, the server computer 112 may include internal components 802b and external components 804b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

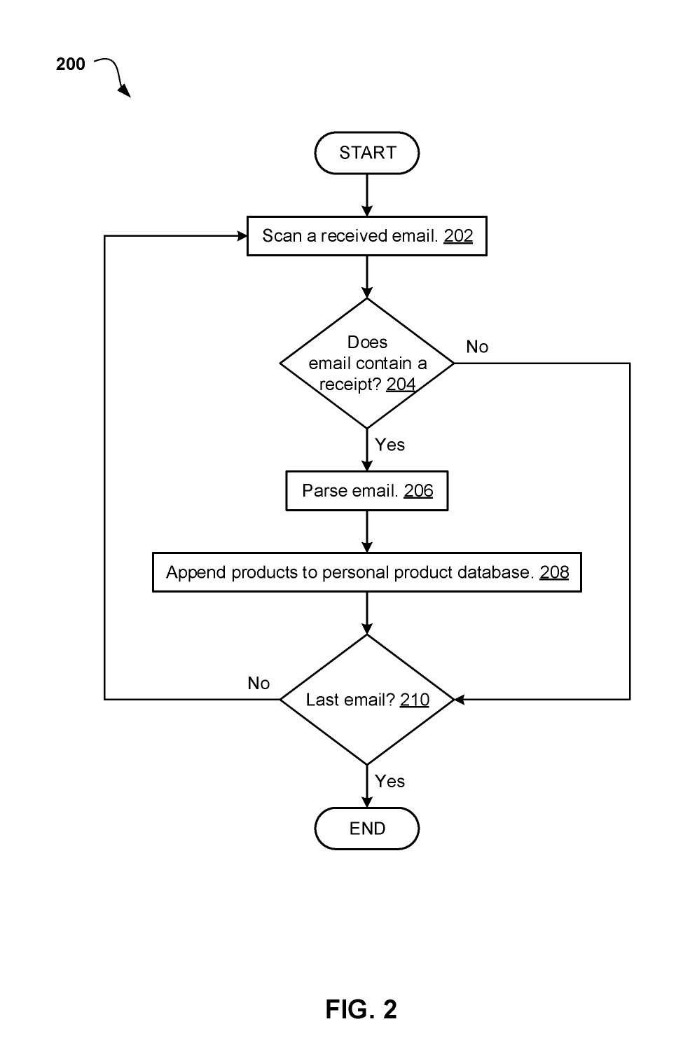

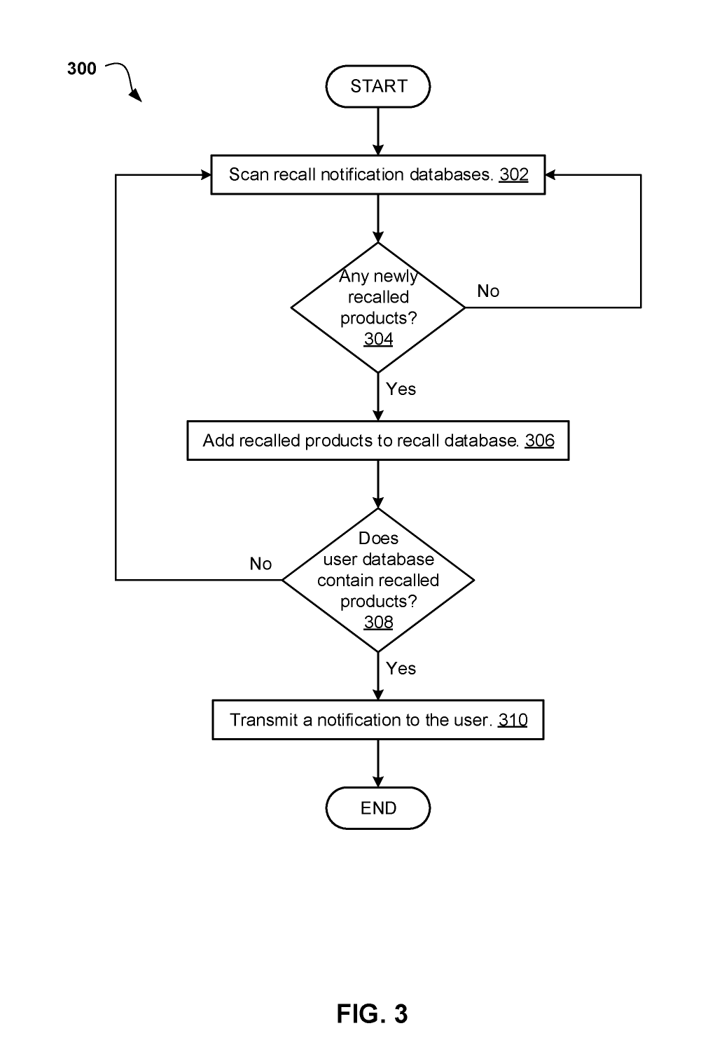

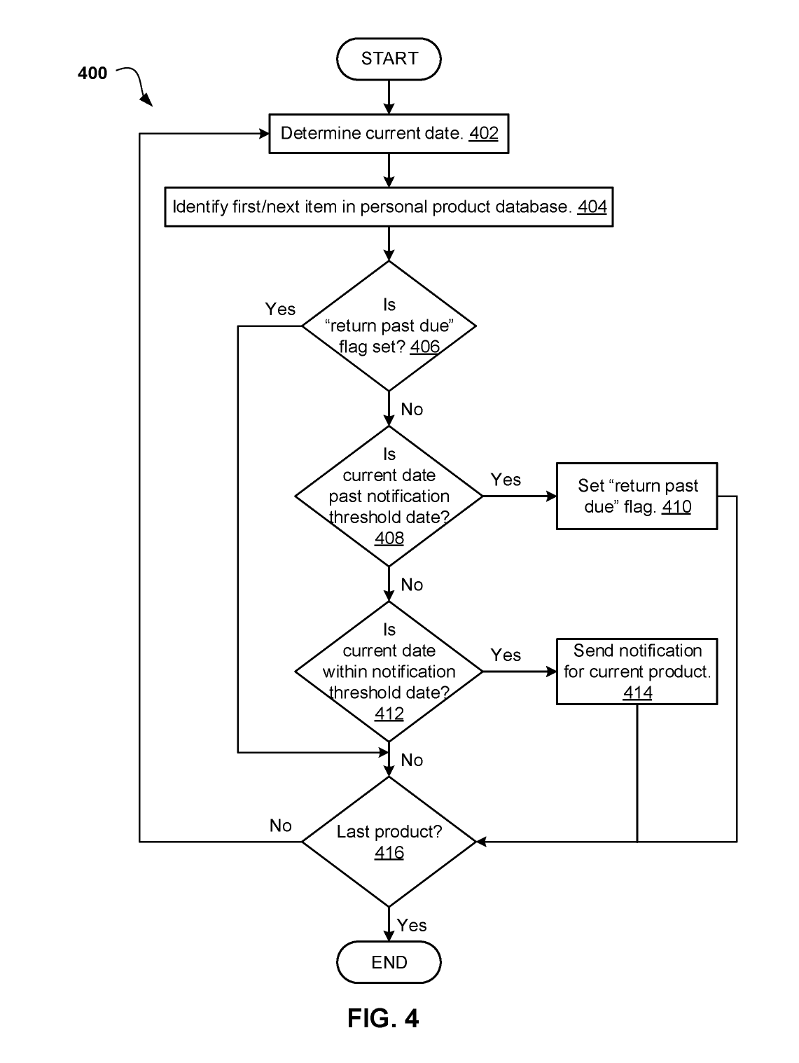

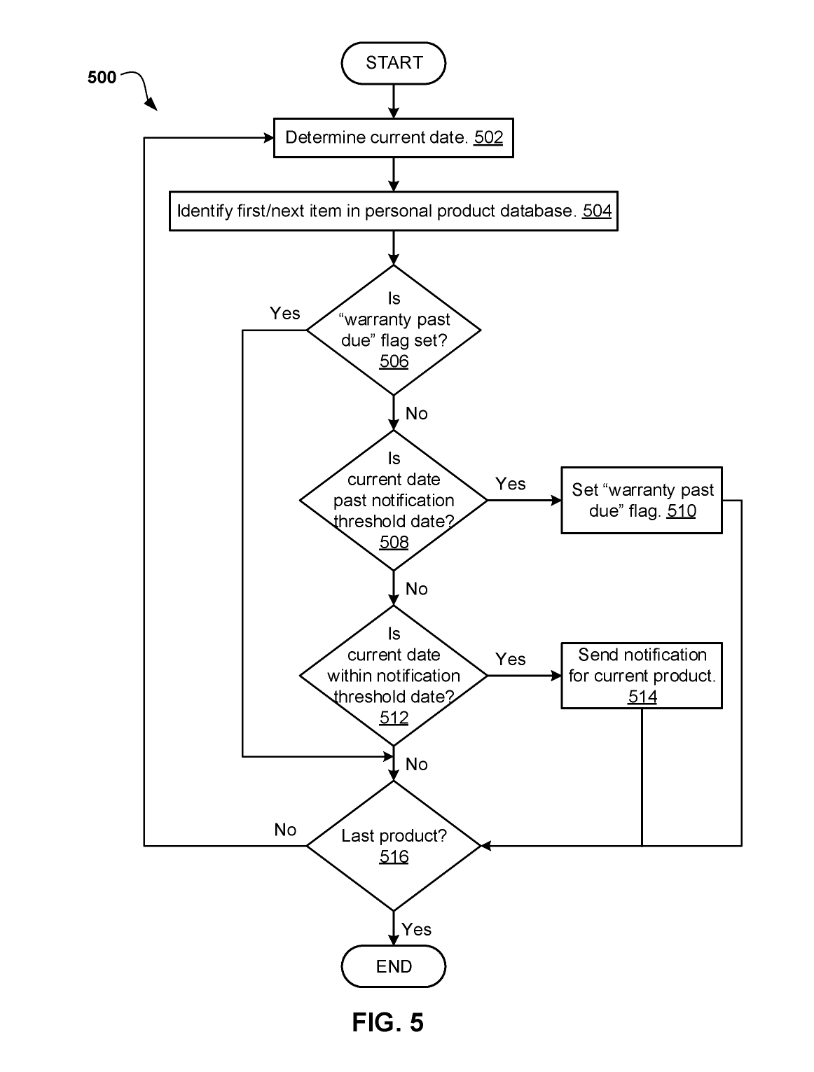

According to the present embodiment, the product notification program 110A, 110B may be a program capable of parsing a user messaging account to identify receipts for recently purchased products by the user. The product notification program 110A, 110B may then generate a database that maintains information relevant to each identified receipt so that various post-purchase events, such as recalls, warranty expirations, and return deadlines, may be monitored and appropriate notifications may be transmitted to the user. The personal product database creation method is explained in further detail below with respect to FIG. 2. The recall notification process is explained in further detail below with respect to FIG. 3. The return deadline notification process is explained in further detail below with respect to FIG. 4. The warranty notification process is explained in further detail below with respect to FIG. 5.

FIG. 2 is an operational flowchart illustrating a personal product database creation process 200 according to at least one embodiment. At 202, the product notification program 110A, 110B scans each received email. In modern commerce, many businesses offer customers the ability to receive receipts for purchases via electronic messages, such as email or text messages. In such situations, the business may compose and transmit a message to a purchasing customer that details each item with information normally present on a paper receipt. Such receipts may be received by consumers for purchases made via online enterprises as well as brick-and-mortar retailers and service providers. In order to identify messages containing receipts for purchased products, the product notification program 110A, 110B may analyze each message received in a user account using known natural language processing techniques, such as natural language understanding, to determine when a received email contains a receipt. In at least one embodiment, the product notification program 110A, 110B may be preconfigured to scan a user's entire messaging account on a periodic basis, such as weekly or daily, rather than upon each received message to determine newly received messages that contain receipts. Such a scanning method may allow the user to review and delete messages that are impertinent to the user, such as spam emails, thereby conserving system resources that would be expended scanning messages that are blatantly unrelated to receipts or any item of importance to the user. In at least one other embodiment, the product notification program 110A, 110B may not scan the user account at all but rather require the user to manually designate or select newly received messages that contain product receipts. In yet another embodiment, if a user does not choose to allow the product notification program 110A, 110B to scan the user account, the product notification program 110A, 110B may utilize an auto-forwarding system to flag each message containing preconfigured keywords, such as “receipt” and “purchase”, to allow receipt-related messages to be forwarded to a backend server, such as server 112, for analysis. Additionally, multiple messages may be linked together for a single user or multiple users, such as married couples and roommates. Although many examples are stated towards email messaging systems, the product notification program 110A, 110B may also be implemented for any type of messaging system, such as text messaging systems and social networking systems.

Then, at 204, the product notification program 110A, 110B determines whether a scanned message contains a receipt. According to one implementation, the personal product database creation process 200 may continue if a scanned message is determined to contain a receipt. As previously described, the product notification program 110A, 110B may determine that a message contains a receipt through the application of known natural language processing techniques. If product notification program 110A, 110B determines a scanned message does contain a receipt (step 204, “Yes” branch), the personal product database creation process 200 may continue to step 206 to parse the scanned message. If the product notification program 110A, 110B determines the scanned message does not contain a receipt (step 204, “No” branch), the personal product database creation process 200 may continue to step 210 to determine whether the scanned message is the last remaining message in the user account that had not yet been scanned by the product notification program 110A, 110B.

Next, at 206, the product notification program 110A, 110B parses the message. Once messages containing receipts are identified, the product notification program 110A, 110B may use similar natural language processing techniques to parse the scanned message and identify individual products within the receipt. The user may preconfigure the product notification program 110A, 110B to monitor or ignore specific items for post purchase events based on one or more product criteria, such as item purchase price, category of purchased item, inherent danger of item. For example, a grocery store receipt may contain spinach, cereal, and laundry detergent. Since leafy greens have been linked to food borne illness outbreaks, the product notification program 110A, 110B may track post purchase events, such as a product recall, for the spinach since spinach belongs to a category of purchased items (i.e., leafy greens) the user may wish to have the product notification program 110A, 110B monitor. Conversely, the product notification program 110A, 110B may not track post purchase events for the laundry detergent, since the laundry detergent may not possess specific criteria with which the user wishes tracked.

Then, at 208, the product notification program 110A, 110B appends products to a personal product database. The personal product database may be a repository that includes information related to products purchased by a user, such as purchase date, model number, serial number, product name, product manufacturer, and product retailer. When the product notification program 110A, 110B identifies a product in the parsed message should be monitored for post purchase events, the product notification program 110A, 110B may add the specific product to a repository, such as database 116, to enable the product notification program 110A, 110B to periodically monitor for upcoming or recently occurring post purchase events. For example, in the previously described situation, the product notification program 110A, 110B may determine the spinach purchased by the user at a grocery store and documented on the emailed grocery receipt should be added to the personal product database since the spinach belongs to a category of purchased items the user may wish to monitor. If the product is the first to be added to the personal product database, the product notification program 110A, 110B may generate the personal product database prior to adding the product and related product information. Similarly, if an emailed receipt documents that the user recently purchased a generator from a hardware store, the product notification program 110A, 110B may determine to add item data for the generator to the personal product database since the generator likely satisfies one or more product criteria configured by the user (e.g., product purchase price and/or category of purchased item). When appending the purchased product to the repository, the product notification program 110A, 110B may include product metadata, such as product name, universal product code (UPC), product serial number, product part number, product purchase price, size of product purchased, quantity of product purchased, purchase date, product manufacturer, product seller, product size, warranty expiration date, retailer location where product purchased, retailer return policy information, retailer contact information, and manufacturer contact information.

The personal product database may be viewable by the user to allow the user to identify return and warranty expiration dates. Additionally, users can identify specific products with which to receive notifications a preconfigured number of days prior to the expiration dates so that the user has adequate time to contact the retailer and/or manufacturer regarding and issues or concerns. Similarly, a user can configure the product notification program 110A, 110B to transmit a notification for only those products above a threshold purchase price. When providing notifications, the product notification program 110A, 110B may include contact information for the manufacturer and/or retailer from which the product was purchased.

In at least one embodiment, the product notification program 110A, 110B may allow the user to manually enter product information to the repository by selecting the product from a list or capturing an image of the product or an image of a physical receipt from a brick-and-mortar retailer. When a product is already owned by the user when the product notification program 110A, 110B is adopted or when a product is received as a gift, the user may not possess a receipt with which to scan or capture information from. Therefore, allowing the user to manually input the product to the product notification program 110A, 110B enables the user to track post purchase product events for already owned and/or gifted products.

In at least one other embodiment, the product notification program 110A, 110B may receive warranty information for a particular product on a receipt or manually entered by the use from a warranty information database maintained by a retailer or manufacturer since such warranty information may not be located on a receipt. Database 116 may also store warranty and/or return policy information for specific items or retailers that are uploaded by other users.

Next, at 210, the product notification program 110A, 110B determines whether there are any remaining messages to be scanned. According to one implementation, the personal product database creation process 200 may continue if a scanned message is not the last message to be scanned in the user account. As previously described, the product notification program 110A, 110B may scan each message received in the user account as each message is received. Similarly, the product notification program 110A, 110B be configured to periodically scan the user account so that groups of messages may be scanned at once. If product notification program 110A, 110B determines the scanned message is the last remaining message in the user account to be scanned (step 210, “Yes” branch), the personal product database creation process 200 may terminate. If the product notification program 110A, 110B determines the scanned message is not the last remaining message in the user account to be scanned (step 210, “No” branch), the personal product database creation process 200 may continue to step 202 to scan remaining messages in the user account.

Referring now to FIG. 3, an operational flowchart illustrating a recall notification process 300 is depicted according to at least one embodiment. At 302, the product notification program 110A, 110B scans recall notification databases. As previously described, consumers may not always receive information related to product recalls. For example, if a product is not dangerous in lieu of a defect, a manufacturer may issue a recall but not adequately disseminate the recall to consumers. Similarly, such defects may not be disseminated by national media as occurs when consumable products carry dangerous food borne illnesses. To manage product information, a retailer and/or product manufacturer may maintain a database of products that includes product recall information. Periodically, the product notification program 110A, 110B may scan product databases for recalls with which consumers should be notified. For example, the product notification program 110A, 110B may be configured to scan the product database of each retailer and/or manufacturer associated with each product in the personal product database of products purchased by the user. In at least one embodiment, the product notification program 110A, 110B may also scan product forums and product reviews for extraneous information that may be critical of which a purchasing user should be made aware. For example, if a user purchases dog food for a pet and subsequent purchasers of that same brand of dog food have experienced illness in their pets after being fed the subject dog food, the user may wish to be made aware of the issue despite an official product recall not yet being issued by the retailer or manufacturer.

Then, at 304, the product notification program 110A, 110B determines whether any products have been newly recalled. According to one implementation, the recall notification process 300 may continue if any newly recalled products are detected in a product information database maintained by a retailer, manufacturer, trade organization, government entity, etc. The product notification program 110A, 110B may determine a product has been recalled by searching relevant information related to recently issued recalls. If product notification program 110A, 110B determines a product has been recently recalled (step 304, “Yes” branch), the recall notification process 300 may continue to step 306 to add the recalled products to a recall database. If the product notification program 110A, 110B determines no products have been recently recalled (step 304, “No” branch), the recall notification process 300 may return to step 302 to scan additional recall notification databases. In at least one embodiment, if the product notification program 110A, 110B determines that no products have been recently recalled (step 304, “No” branch), the recall notification process 300 may terminate.

In at least one embodiment, when searching for recalled products, the product notification program 110A, 110B may search by part number or serial number rather than product name since a production change during manufacturing may result in only a portion of products being affected by a recall. Similarly, the product notification program 110A, 110B may consider purchase date, packaging date, and/or manufacturing date when identifying a recall since it is possible only products before or after a specific date are affected by a recall. Furthermore, product purchase location may be accounted for during recall verification. For example, tomatoes produced by a particular farm may be recalled and those tomatoes may have only been distributed to five different stores so only users purchasing tomatoes from those five store locations may need to receive recall notifications.

In at least one embodiment, the product notification program 110A, 110B may also notify a user when a product recall is likely to occur based on analyzed product reviews and product forum posts. For example, if multiple user reviews reveal that a pet food is making pets sick, the product notification program 110A, 110B may analyze the user product reviews and calculate a recall likelihood score based on the number of reviews containing the occurrence versus the number of reviews not containing the occurrence. When the product notification program 110A, 110B determines the recall likelihood score satisfies a threshold value, the product notification program 110A, 110B may determine a notification should be sent to the user as if a recall had already been issued.

Next, at 306, the product notification program 110A, 110B adds the recently recalled products to a recall database. Once the product notification program 110A, 110B determines that a product has been recently recalled, the product notification program 110A, 110B may add the product to a recall database maintained on either the client computing device 102 or the server 112. The recall database may be maintained so that the user may be notified if any products subsequently purchased to the recall issuance happen to be purchased by the user. For example, if the user purchases a product at a garage sale and the product was the subject of a manufacture's recall due a product defect, the product notification program 110A, 110B may notify the user of the recall so the user may take appropriate action.

Then, at 308, the product notification program 110A, 110B determines whether the user's personal product database contains any recalled products. According to one implementation, the recall notification process 300 may continue if any newly recalled products are detected in the personal product database associated with the user. By comparing the products in the recall database and the personal product database, the product notification program 110A, 110B may determine whether the user previously purchased any products that have been recently recalled. The product notification program 110A, 110B may determine the user purchased or owns a product that is subject to a recall if the product appears on both the personal product database associated with the user and the recall database. If product notification program 110A, 110B determines the personal products database contains a recalled product (step 308, “Yes” branch), the recall notification process 300 may continue to step 310 to transmit a notification to the user. If the product notification program 110A, 110B determines the personal products database does not contain a recalled product (step 308, “No” branch), the recall notification process 300 may return to step 302 to scan additional recall notification databases.

Next, at 310, the product notification program 110A, 110B sends a notification to the current user account. Once the product notification program 110A, 110B has determined that the user has a recalled product in the user's personal product database, the product notification program 110A, 110B may compose and send a notification to the user regarding the recalled product. The notification may include product identifying information, such as product name, serial number, part number, and/or model number, to allow the user to know which product is the subject of the recall as well as reasons for the recall and actionable information, such as manufacturer name, retailer name, and manufacturer and/or retailer contact information. For example, if romaine lettuce that was sold by XYZ grocery store is the subject of a recall and that specific product is in the personal products database associated with the user, the product notification program 110A, 110B may compose a notification to the user that identifies the romaine lettuce as being subject to a recall due to possible E. coli contamination and the user is warned not to consume the product and return it to the retailer, XYZ grocery store. In at least one embodiment, once transmitting the notification to the current user account, the product notification program 110A, 110B may return to step 302 and iterate through the recall notification process 300 again for a different user account since recalls may apply to all users that have purchased a product and, therefore, all purchasing users should receive a recall notification.

In at least one embodiment, rather than only searching recall databases for recalled products, the product notification program 110A, 110B may also scan product review databases and/or websites and product forums for reviews and posts relevant to the purchased product. Since product reviews and user posts may include information relevant to products that have not yet been recalled, purchasing users may benefit from being notified of other purchasing users having issues with the purchased product. For example, in the earlier described situation relevant to a user purchasing dog food that made other users' pets ill, the user may wish to be made aware of forum posts and product reviews that detail issues with the purchased dog food so as to avoid feeding the possible tainted food to a pet.

Referring now to FIG. 4, an operational flowchart illustrating a return deadline notification process 400 is depicted according to at least one embodiment. At 402, the product notification program 110A, 110B determines the current date. In order to adequately determine whether a return deadline is approaching for a retailer or manufacturer, the product notification program 110A, 110B may identify the current date based on the time and calendar settings of the device on which the product notification program 110A, 110B is operating (i.e., client computing device 102 or server 112). For example, the product notification program 110A, 110B may utilize the calendar settings of client computing device 102 to determine that the current date is Jan. 19, 2018.

Then, at 404, the product notification program 110A, 110B identifies an item in the personal product database. The product notification program 110A, 110B may parse through the personal product database to analyze each item for the return deadline associated with each product. For example, the product notification program 110A, 110B may determine the personal product database includes five items, and identify a generator as the first item to within the database.

Next, at 406, the product notification program 110A, 110B determines whether a return past due flag is set. According to one implementation, the return deadline notification process 400 may continue if any newly recalled products are detected in the personal product database associated with the user. When determining whether a return deadline is approaching, the product notification program 110A, 110B may first determine whether a return deadline has already passed and, therefore, further analysis is irrelevant. The product notification program 110A, 110B may determine a return deadline has passed by comparing the current date to the return deadline as detailed in the personal product database entry for the specific product. For example, in the previously described situation, if the product notification program 110A, 110B determined the return deadline for the identified generator in the personal products database is Dec. 19, 2017 and the current date is Jan. 19, 2018, then the product notification program 110A, 110B may bypass further analysis of whether a notification of an approaching return deadline should be transmitted to the user since the return deadline has already passed. If product notification program 110A, 110B determines the return past due flag is set (step 406, “Yes” branch), the return deadline notification process 400 may continue to step 416 to determine whether any products remain in the product database to be analyzed. If the product notification program 110A, 110B determines the return past due flag is not set (step 406, “No” branch), the return deadline notification process 400 may continue to step 408 to determine whether the current date is past a return notification threshold date.

Then, at 408, the product notification program 110A, 110B determines whether the current date is past a return notification threshold date. According to one implementation, the return deadline notification process 400 may continue if the current date is not past the return notification date threshold. The return notification date threshold may be a preconfigured time period before a return deadline within which the product notification program 110A, 110B may notify the user of the approaching return deadline. For example, the product notification program 110A, 110B may be preconfigured with a one week return notification date threshold so that the user is notified of an approaching return deadline one week prior to the return deadline date. If the return past due flag is not set, then the product notification program 110A, 110B did not previously determine that the return notification threshold date had passed and, therefore, returning the product may still be possible. For example, a product return deadline may be January 30 and the product notification program 110A, 110B may be preconfigured to notify the user one week prior to the return deadline. Since time may have elapsed and the current date may now be approaching or past the return deadline, the product notification program 110A, 110B may compare the current date against a return notification date threshold. If product notification program 110A, 110B determines the current date is past the return notification date threshold (step 408, “Yes” branch), the return deadline notification process 400 may continue to step 410 to set the return past due flag. If the product notification program 110A, 110B determines the current date is not past the return notification threshold date (step 408, “No” branch), the return deadline notification process 400 may continue to step 410 to determine whether the current date is within a notification threshold date.

Next, at 410, the product notification program 110A, 110B sets the return past due flag. If the product notification program 110A, 110B determines that the current date is past the return notification threshold date, then the product notification program 110A, 110B may set the return past due flag for the product in the personal product database since a notification may have already been transmitted to the user about the approaching return deadline. For example, in the previously described example, if the current date is January 24, the product return deadline is January 30 and the recall notification date threshold is preconfigured for one week prior to the return deadline (i.e., January 23), then the product notification program 110A, 110B may determine the return notification date threshold has passed since the product notification program 110A, 110B should have previously sent a notification of the approaching return deadline to the user and no further notifications may be needed. Therefore, in this scenario, the product notification program 110A, 110B may set the return past due flag so that no further notifications are transmitted to the user. Once the return past due flag is set, the return deadline notification process 400 may continue to step 416 to determine whether any products remain in the product database to be analyzed.

Then, at 412, the product notification program 110A, 110B determines whether the current date is within the notification threshold date. According to one implementation, the return deadline notification process 400 may continue if the current date is within the return notification date threshold. Similar to step 408, the product notification program 110A, 110B may determine if the current date is within the return notification date threshold by comparing the current date against the return notification date threshold. If product notification program 110A, 110B determines the current date is within the return notification date threshold (step 412, “Yes” branch), the return deadline notification process 400 may continue to step 414 to send a notification to the user for the current product. If the product notification program 110A, 110B determines the current date is not within the return notification threshold date (step 412, “No” branch), the return deadline notification process 400 may continue to step 416 to determine whether the current product is the last product in the personal product database to be scanned.

Next, at 414, the product notification program 110A, 110B sends a notification for the current product. If the product notification program 110A, 110B determines a notification should be transmitted for the current product based on steps 406, 408, and 412, the product notification program 110A, 110B may compose the notification with relevant information, such as the current product name, the current product serial number, the current product model number, current product part number, product manufacturer, purchasing retailer name, purchasing retailer location, purchasing retailer contact information, and return deadline. Once the notification for the current product has been sent, the return deadline notification process 400 may continue to step 416 to determine whether any products remain in the product database to be analyzed.

In at least one embodiment, the product notification program 110A, 110B may be preconfigured to transmit notifications to the user periodically until the return deadline has itself expired. For example, the product notification program 110A, 110B may transmit a daily notification to the user beginning one week prior to the return deadline and ceasing the transmission of notifications on the day after the return deadline. Similarly, the product notification program 110A, 110B may be preconfigured to transmit a notification only on the first day of the notification threshold and the last day before the return deadline so as to prevent spamming the user with notifications. In some embodiments, the number of notifications may vary based on the product price or based on product reviews (i.e., a product that has many positive reviews may generate only one return notification while a product with many poor reviews may generate more than one notification because the likelihood of the user wanting to return the item is greater).

Then, at 416, the product notification program 110A, 110B determines whether any products remain in the product database to be analyzed. According to one implementation, the return deadline notification process 400 may continue if any products in the personal product database have not yet been analyzed for a return status. If product notification program 110A, 110B determines the current product is the last product in the personal product database to be analyzed (step 416, “Yes” branch), the return deadline notification process 400 may terminate. If the product notification program 110A, 110B determines other products in the personal product database need to be analyzed (step 416, “No” branch), the return deadline notification process 400 may return to step 402 to determine the current date.

Referring now to FIG. 5, an operational flowchart illustrating a warranty notification process 500 is depicted according to at least one embodiment. At 502, the product notification program 110A, 110B determines the current date. Similar to step 402, in order to adequately determine whether a warranty expiration is approaching for a retailer or manufacturer, the product notification program 110A, 110B may identify the current date based on the time and calendar settings of the device on which the product notification program 110A, 110B is operating (i.e., client computing device 102 or server 112). For example, the product notification program 110A, 110B may utilize the calendar settings of client computing device 102 to determine that the current date is Jan. 19, 2018.

Then, at 504, the product notification program 110A, 110B identifies an item in the personal product database. The product notification program 110A, 110B may parse through the personal product database to analyze each item for the warranty expiration associated with each product. For example, the product notification program 110A, 110B may determine the personal product database includes five items, and identify a generator as the first item to within the database.

Next, at 506, the product notification program 110A, 110B determines whether a warranty past due date is set. According to one implementation, the warranty expiration notification process 500 may continue if a warranty past due flag is set. When determining whether a warranty expiration is approaching, the product notification program 110A, 110B may first determine whether a warranty expiration has already passed and, therefore, further analysis is irrelevant. The product notification program 110A, 110B may determine a warranty expiration has passed by comparing the current date to the warranty expiration as detailed in the personal product database entry for the specific product. For example, in the previously described situation, if the product notification program 110A, 110B determined the warranty expiration for the identified generator in the personal products database is Dec. 19, 2017 and the current date is Jan. 19, 2018, then the product notification program 110A, 110B may bypass further analysis of whether a notification of an approaching warranty expiration should be transmitted to the user since the warranty expiration has already passed. If product notification program 110A, 110B determines the warranty past due flag is set (step 506, “Yes” branch), the warranty expiration notification process 500 may continue to step 516 to determine whether any products remain in the product database to be analyzed. If the product notification program 110A, 110B determines the warranty past due flag is not set (step 506, “No” branch), the warranty expiration notification process 500 may continue to step 508 to determine whether the current date is past a warranty notification threshold date.

Then, at 508, the product notification program 110A, 110B determines whether the current date is past a notification threshold date. According to one implementation, the warranty expiration notification process 500 may continue if the current date is not past the warranty notification date threshold. The warranty notification date threshold may be a preconfigured time period before a warranty expiration date within which the product notification program 110A, 110B may notify the user of the approaching warranty expiration date. For example, the product notification program 110A, 110B may be preconfigured with a one week warranty notification date threshold so that the user is notified of an approaching warranty expiration date one week prior to the warranty expiration. If the warranty past due flag is not set, then the product notification program 110A, 110B did not previously determine that the warranty notification threshold date had passed and, therefore, the product warranty may still be in effect. For example, a warranty may expire on January 30 and the product notification program 110A, 110B may be preconfigured to notify the user one week prior to the warranty expiration date. Since time may have elapsed and the current date may now be approaching or past the warranty expiration date, the product notification program 110A, 110B may compare the current date against a warranty notification date threshold. If product notification program 110A, 110B determines the current date is past the warranty notification date threshold (step 508, “Yes” branch), the warranty expiration notification process 500 may continue to step 510 to set the warranty past due flag. If the product notification program 110A, 110B determines the current date is not past the warranty notification threshold date (step 508, “No” branch), the warranty expiration notification process 500 may continue to step 510 to determine whether the current date is within a warranty notification threshold date.

Next, at 510, the product notification program 110A, 110B sets the warranty past due flag. If the product notification program 110A, 110B determines that the current date is past the warranty notification threshold date, then the product notification program 110A, 110B may set the warranty past due flag for the product in the personal product database since a notification may have already been transmitted to the user about the approaching warranty expiration. For example, in the previously described example, if the current date is January 24, the warranty expires on January 30 and the warranty notification date threshold is preconfigured for one week prior to the return deadline (i.e., January 23), then the product notification program 110A, 110B may determine the warranty notification date threshold has passed since the product notification program 110A, 110B should have previously sent a notification of the approaching warranty expiration to the user and no further notifications may be needed. Therefore, in this scenario, the product notification program 110A, 110B may set the warranty past due flag so that no further notifications are transmitted to the user. Once the warranty past due flag is set, the warranty expiration notification process 500 may continue to step 516 to determine whether any products remain in the product database to be analyzed.

Then, at 512, the product notification program 110A, 110B determines whether the current date is within the notification threshold date. According to one implementation, the warranty expiration notification process 500 may continue if the current date is within the warranty notification date threshold. Similar to step 508, the product notification program 110A, 110B may determine if the current date is within the warranty notification date threshold by comparing the current date against the warranty notification date threshold. If product notification program 110A, 110B determines the current date is within the warranty notification date threshold (step 512, “Yes” branch), the warranty expiration notification process 500 may continue to step 514 to send a warranty expiration notification to the user for the current product. If the product notification program 110A, 110B determines the current date is not within the warranty notification threshold date (step 512, “No” branch), the warranty expiration notification process 500 may continue to step 516 to determine whether the current product is the last product in the personal product database to be scanned.

Next, at 514, the product notification program 110A, 110B sends a notification for the current product. If the product notification program 110A, 110B determines a notification should be transmitted for the current product based on steps 506, 508, and 512, the product notification program 110A, 110B may compose the notification with relevant information, such as the current product name, the current product serial number, the current product model number, current product part number, product manufacturer, purchasing retailer name, purchasing retailer location, purchasing retailer contact information, warranty expiration date, and available warranty extension options. Once the notification for the current product has been sent, the warranty expiration notification process 500 may continue to step 516 to determine whether any products remain in the product database to be analyzed.

In at least one embodiment, the product notification program 110A, 110B may be preconfigured to transmit notifications to the user periodically until the warranty expiration date. For example, the product notification program 110A, 110B may transmit a daily notification to the user beginning one week prior to the warranty expiration date and ceasing the transmission of notifications on the day after the warranty expires. Similarly, the product notification program 110A, 110B may be preconfigured to transmit a notification only on the first day of the notification threshold and the last day before the warranty expires so as to prevent spamming the user with notifications.

In at least one other embodiment, the product notification program 110A, 110B may allow the user to select an option on a graphical user interface to extend the product warranty for a period of time in accordance with retailer or manufacturer terms. For example, the warranty expiration notification may include information that allows the user to either let the warranty expire or extend the product warranty for one year for a manufacturer-established price. The product notification program 110A, 110B may allow the user to select the option to extend the product warranty, and either connect the user with a manufacturer representative to proceed with payment options for the warranty extension or allow the product notification program 110A, 110B to pay for the warranty extension, after user selection to extend the warranty, automatically through payment information previously saved by the user in the product notification program 110A, 110B.

Then, at 516, the product notification program 110A, 110B determines whether any products remain in the product database to be analyzed. According to one implementation, the warranty expiration notification process 500 may continue if any products in the personal product database have not yet been analyzed for a warranty status. If product notification program 110A, 110B determines the current product is the last product in the personal product database to be analyzed (step 516, “Yes” branch), the warranty expiration notification process 500 may terminate. If the product notification program 110A, 110B determines other products in the personal product database need to be analyzed (step 516, “No” branch), the warranty expiration notification process 500 may return to step 502 to determine the current date.

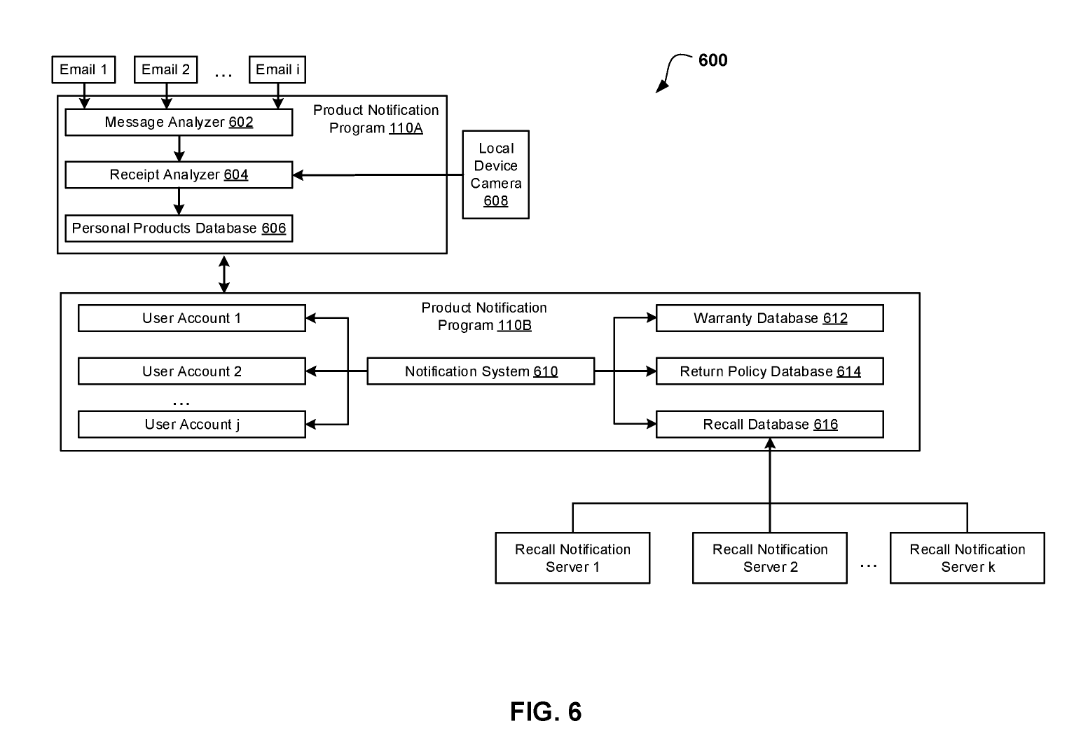

Referring now to FIG. 6, a functional block diagram of a product notification platform 600 is depicted according to at least one embodiment. The product notification platform may include the product notification program 110A installed on the client computing device 102 interacting with one or more user email accounts and the product notification program 110B installed on the server 112 interacting with one or more recall notification servers.

The product notification program 110A may include a message analyzer 602, a receipt analyzer 604, and a personal product database 606. Additionally, the receipt analyzer 604 may receive data (e.g., images) from a local device camera 608 either internally installed or externally connected to the client computing device 102. The receipt analyzer 604 may utilize image recognition technology to determine product information detailed on the received data. The message analyzer 602 may analyze each user messaging account for messages containing receipt or purchase information for products purchased by the user. Once the message analyzer 602 has identified a message contains receipt or product information, the identified message is analyzed by the receipt analyzer 604 to extract the information and generate a personal products database 606. The receipt analyzer 604 may also receive receipt or purchased product information captured by a local device camera 608 and manually supplemented by the user through a graphical user interface.

Once the personal products database 606 is generated by the product notification program 110A, the product notification program 110B may associate the personal products database 606 with one or more user accounts. The product notification program 110B may thereby utilize a notification system 610 to monitor each product associated with each user account and one or more warranty databases 612, one or more return policy databases 614, and one or more recall databases 614. The warranty database 612, return policy database 614, and recall database 616 may contain warranty, return policy, and recall information, respectively, for each item in the personal products database 606 and associated with each user account. As previously described, the information in the warranty database 612 and the return policy database 616 may be obtained when the product notification program 110A analyzes each receipt. In at least one embodiment, the product notification program 110B may obtain warranty information and return information from one or more databases associated with a retailer or a product manufacturer if such information is not available on the analyzed product receipt. Since recall information may only be maintained and/or distributed by retailers and manufacturers, the product notification program 110B may obtain recall information from one or more recall notification servers maintained by a retailer and/or a manufacturer.

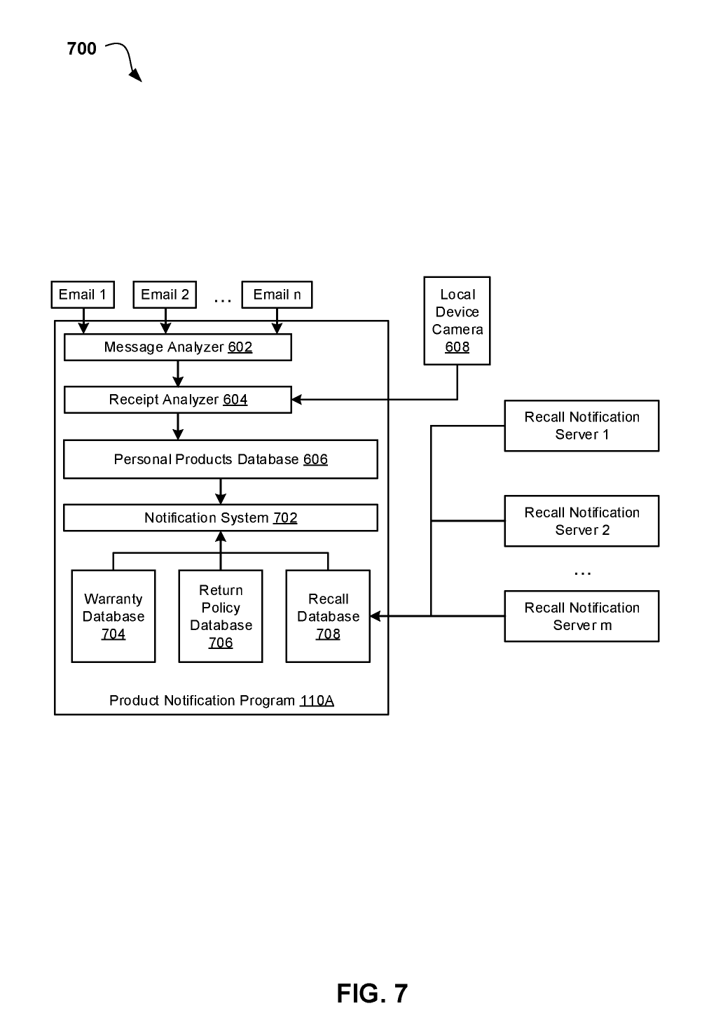

Referring now to FIG. 7, a functional block diagram of a locally executed product notification platform 700 is depicted according to at least one embodiment. In at least one embodiment, the product notification program 110A may only operate locally on a client computing device 102 without the need for a counterpart installation of product notification program 110B on a backend server 112. Modules previously described as being hosted locally on the client computing device (i.e., message analyzer 602, receipt analyzer 604, and personal products database 606) as well as the local device camera 608 may remain associated with the client computing device as previously described in FIG. 6. However, modules previously described as being hosted by the backend server 112 (i.e., notification system 610, warranty database 612, return policy database 614, and recall database 616) may now be hosted on the client computing device 102. The notification system 702, warranty database 704, return policy database 706, and recall database 708 may operate the same or substantially similar to notification system 610, warranty database 612, return policy database 614, and recall database 616 as previously described with respect to FIG. 6 despite being hosted on the client computing device 102 rather than the server 112. Periodically, whereas the product notification program 110B scanned recall databases to identify if any purchased products have been recalled, the product notification program 110A may now scan retailer and manufacturer recall databases.

It may be appreciated that FIGS. 2-7 provide only an illustration of one implementation and do not imply any limitations with regard to how different embodiments may be implemented. Many modifications to the depicted environments may be made based on design and implementation requirements. For example, in at least one embodiment, warranty databases and recall databases may be updated by application developers of the product notification program 110A, 110B and pushed to users via application updates.

FIG. 8 is a block diagram 800 of internal and external components of the client computing device 102 and the server 112 depicted in FIG. 1 in accordance with an embodiment of the present invention. It should be appreciated that FIG. 8 provides only an illustration of one implementation and does not imply any limitations with regard to the environments in which different embodiments may be implemented. Many modifications to the depicted environments may be made based on design and implementation requirements.

The data processing system 802, 804 is representative of any electronic device capable of executing machine-readable program instructions. The data processing system 802, 804 may be representative of a smart phone, a computer system, PDA, or other electronic devices. Examples of computing systems, environments, and/or configurations that may represented by the data processing system 802, 804 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 802 a,b and external components 804 a,b illustrated in FIG. 8. Each of the sets of internal components 802 include one or more processors 420, one or more computer-readable RAMs 822, and one or more computer-readable ROMs 824 on one or more buses 826, and one or more operating systems 828 and one or more computer-readable tangible storage devices 830. The one or more operating systems 828, the software program 108 and the product notification program 110A in the client computing device 102 and the product notification program 110B in the server 112 are stored on one or more of the respective computer-readable tangible storage devices 830 for execution by one or more of the respective processors 820 via one or more of the respective RAMs 822 (which typically include cache memory). In the embodiment illustrated in FIG. 8, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 802 a,b also includes a R/W drive or interface 832 to read from and write to one or more portable computer-readable tangible storage devices 838 such as a CD-ROM, DVD, memory stick, magnetic tape, magnetic disk, optical disk or semiconductor storage device. A software program, such as the product notification program 110A, 110B, can be stored on one or more of the respective portable computer-readable tangible storage devices 838, read via the respective R/W drive or interface 832, and loaded into the respective hard drive 830.

Each set of internal components 802 a,b also includes network adapters or interfaces 836 such as a TCP/IP adapter cards, wireless Wi-Fi interface cards, or 3G or 4G wireless interface cards or other wired or wireless communication links. The software program 108 and the product notification program 110A in the client computing device 102 and the product notification program 110B in the server 112 can be downloaded to the client computing device 102 and the server 112 from an external computer via a network (for example, the Internet, a local area network or other, wide area network) and respective network adapters or interfaces 836. From the network adapters or interfaces 836, the software program 108 and the product notification program 110A in the client computing device 102 and the product notification program 110B in the server 112 are loaded into the respective hard drive 830. The network may comprise copper wires, optical fibers, wireless transmission, routers, firewalls, switches, gateway computers and/or edge servers.

Each of the sets of external components 804 a,b can include a computer display monitor 844, a keyboard 842, and a computer mouse 834. External components 804 a,b can also include touch screens, virtual keyboards, touch pads, pointing devices, and other human interface devices. Each of the sets of internal components 802 a,b also includes device drivers 840 to interface to computer display monitor 844, keyboard 842, and computer mouse 834. The device drivers 840, R/W drive or interface 832, and network adapter or interface 836 comprise hardware and software (stored in storage device 830 and/or ROM 824).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

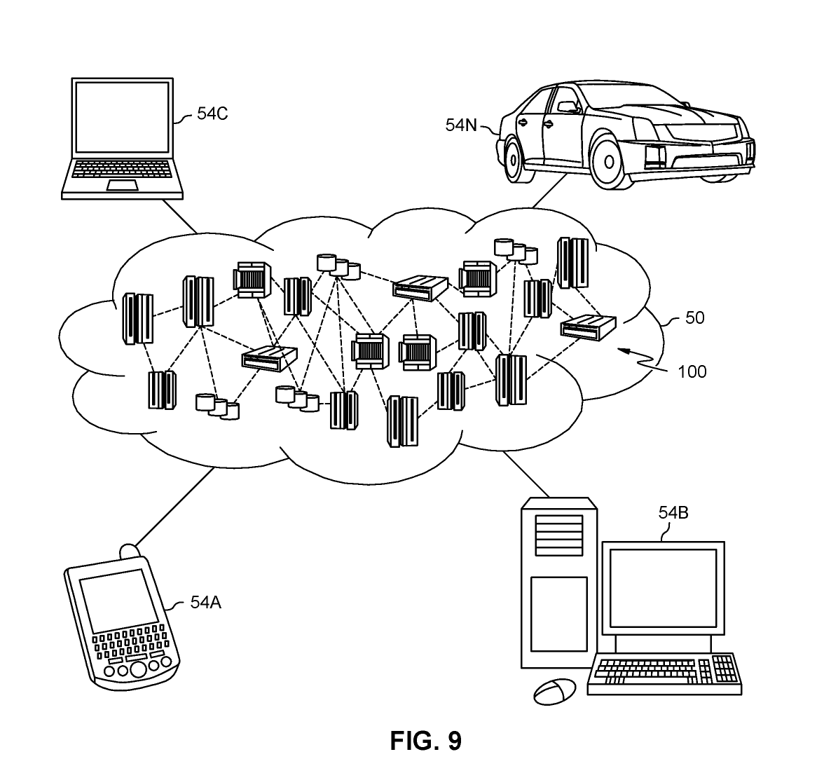

Referring now to FIG. 9, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 9 are intended to be illustrative only and that computing nodes 100 and cloud computing environment 50 can communicate with any type of computerized device over any type of network and/or network addressable connection (e.g., using a web browser).

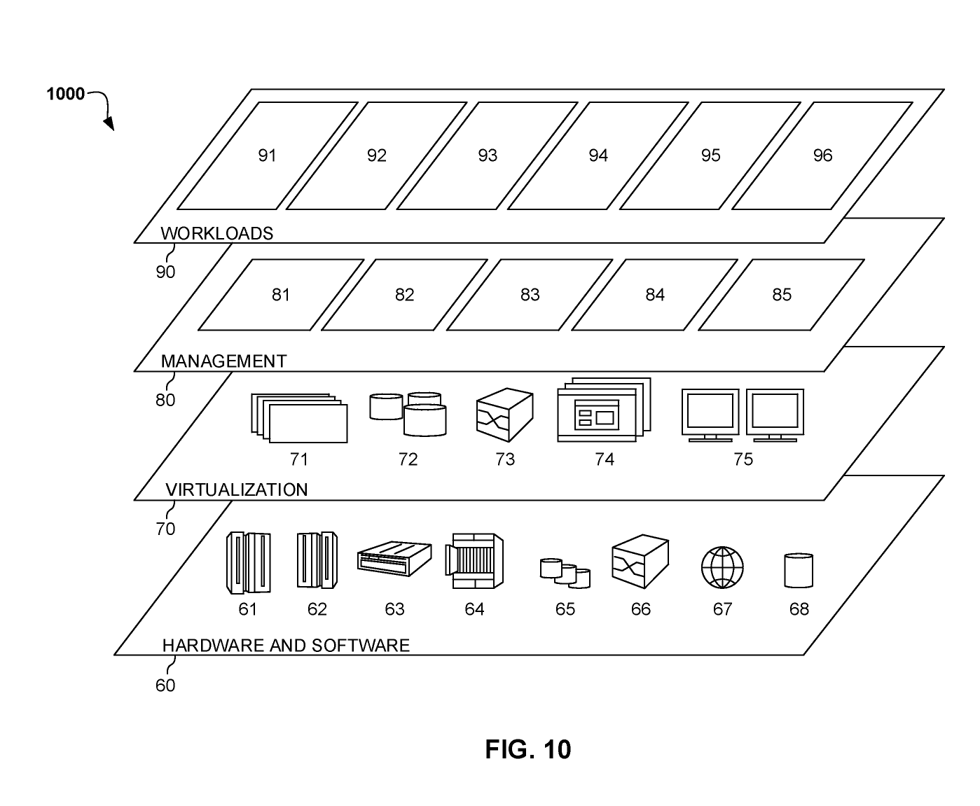

Referring now to FIG. 10, a set of functional abstraction layers 1000 provided by cloud computing environment 50 is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and product notifications 96. Product notifications 96 may relate generating a database of products previously-purchased by a user, monitoring various databases for post-purchase events for which the user may be interested in receiving a notification, such as warranty expiration, product recall, or retailer return deadline, and transmitting the notification to the user.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for generating purchased product recall, warranty, and return notifications, the method comprising:
identifying, by a processor, a product within a personal product database;
determining a post-purchase event for the identified product has occurred;
generating a notification detailing a plurality of information related to the determined post-purchase event; and
transmitting the notification to a user.

2. The method of claim 1, further comprises:
identifying one or more messages within a user messaging account that include a plurality of product purchasing information for one or more products; and
generating the personal product database to include each product in the one or more identified messages using the plurality of product purchasing information associated with each product.

3. The method of claim 2, further comprising:
receiving image data of a product receipt from an image capturing device;
determining the plurality of product purchasing information using image recognition technology.

4. The method of claim 1, wherein the post-purchase event is selected from a group consisting of a warranty expiration, a product recall, and a product return deadline.

5. The method of claim 4, further comprising:
in response to the post-purchase event being a product recall or a possible product recall based on an analyzed product review or product forum post:
determining a recall notice has been issued, or will be issued based on a recall likelihood score satisfying a threshold, for the identified product within the personal product database based on analyzing one or more recall databases associated with the product and managed by a retailer, a manufacturer, a trade organization, or a government entity; and
generating the notification as a recall notification or a possible product recall notification, wherein the recall notification and the possible product recall notification each include one or more of a product name, a serial number, a part number, a model number, a manufacturer name, a retailer name, a plurality of manufacturer contact information, a plurality of retailer contact information, and a plurality of recall action information, and wherein the possible product recall notification also includes a reason for the possible product recall notification and one or more product reviews or one or more product forum posts supporting the reason.

6. The method of claim 4, further comprising:
in response to the post-purchase event being a product return deadline:
determining a return past due flag has not been set for the identified product; and
in response to determining a current date is not past the product return deadline and is within a preconfigured return notification threshold period, generating the notification as a return deadline notification, wherein the return deadline notification includes one or more of a product name, a serial number, a model number, a part number, a manufacturer name, a retailer name, a purchasing location, a purchasing location contact information, and a return deadline.

7. The method of claim 4, further comprising:
in response to the post-purchase event being a warranty expiration deadline:
determining a user selection to extend a warranty through a plurality of user interactions with a graphical user interface; and
transmitting the determined user selection to a corresponding retailer or manufacturer with a plurality of payment information needed to extend the warranty.

8. A computer system for generating purchased product recall, warranty, and return notifications, the computer system comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
identifying a product within a personal product database;
determining a post-purchase event for the identified product has occurred;
generating a notification detailing a plurality of information related to the determined post-purchase event; and
transmitting the notification to a user.

9. The computer system of claim 8, further comprises:
identifying one or more messages within a user messaging account that include a plurality of product purchasing information for one or more products; and
generating the personal product database to include each product in the one or more identified email messages using the plurality of product purchasing information associated with each product.

10. The computer system of claim 9, further comprising:
receiving image data of a product receipt from an image capturing device;
determining the plurality of product purchasing information using image recognition technology.

11. The computer system of claim 8, wherein the post-purchase event is selected from a group consisting of a warranty expiration, a product recall, and a product return deadline.

12. The computer system of claim 11, further comprising:
in response to the post-purchase event being a product recall or a possible product recall based on an analyzed product review or product forum post:
determining a recall notice has been issued, or will be issued based on a recall likelihood score satisfying a threshold, for the identified product within the personal product database based on analyzing one or more recall databases associated with the product and managed by a retailer, a manufacturer, a trade organization, or a government entity; and
generating the notification as a recall notification or a possible product recall notification, wherein the recall notification and the possible product recall notification each include one or more of a product name, a serial number, a part number, a model number, a manufacturer name, a retailer name, a plurality of manufacturer contact information, a plurality of retailer contact information, and a plurality of recall action information, and wherein the possible product recall notification also includes a reason for the possible product recall notification and one or more product reviews or one or more product forum posts supporting the reason.

13. The computer system of claim 11, further comprising:
in response to the post-purchase event being a product return deadline:
determining a return past due flag has not been set for the identified product; and
in response to determining a current date is not past the product return deadline and is within a preconfigured return notification threshold period, generating the notification as a return deadline notification, wherein the return deadline notification includes one or more of a product name, a serial number, a model number, a part number, a manufacturer name, a retailer name, a purchasing location, a purchasing location contact information, and a return deadline.

14. The computer system of claim 11, further comprising:
in response to the post-purchase event being a warranty expiration deadline:
determining a user selection to extend a warranty through a plurality of user interactions with a graphical user interface; and
transmitting the determined user selection to a corresponding retailer or manufacturer with a plurality of payment information needed to extend the warranty.

15. A computer program product for generating purchased product recall, warranty, and return notifications, the computer program product comprising:
one or more computer-readable tangible storage media and program instructions stored on at least one of the one or more tangible storage media, the program instructions executable by a processor of a computer to perform a method, the method comprising:
identifying a product within a personal product database;
determining a post-purchase event for the identified product has occurred;
generating a notification detailing a plurality of information related to the determined post-purchase event; and
transmitting the notification to a user.

16. The computer program product of claim 15, further comprises:
identifying one or more messages within a user messaging account that include a plurality of product purchasing information for one or more products; and
generating the personal product database to include each product in the one or more identified email messages using the plurality of product purchasing information associated with each product.

17. The computer program product of claim 16, further comprising:
receiving image data of a product receipt from an image capturing device;
determining the plurality of product purchasing information using image recognition technology.

18. The computer program product of claim 16, wherein the post-purchase event is selected from a group consisting of a warranty expiration, a product recall, and a product return deadline.

19. The computer program product of claim 18, further comprising:
in response to the post-purchase event being a product recall or a possible product recall based on an analyzed product review or product forum post:
determining a recall notice has been issued, or will be issued based on a recall likelihood score satisfying a threshold, for the identified product within the personal product database based on analyzing one or more recall databases associated with the product and managed by a retailer, a manufacturer, a trade organization, or a government entity; and
generating the notification as a recall notification or a possible product recall notification, wherein the recall notification and the possible product recall notification each include one or more of a product name, a serial number, a part number, a model number, a manufacturer name, a retailer name, a plurality of manufacturer contact information, a plurality of retailer contact information, and a plurality of recall action information, and wherein the possible product recall notification also includes a reason for the possible product recall notification and one or more product reviews or one or more product forum posts supporting the reason.

20. The computer program product of claim 18, further comprising:
in response to the post-purchase event being a product return deadline:
determining a return past due flag has not been set for the identified product; and
in response to determining a current date is not past the product return deadline and is within a preconfigured return notification threshold period, generating the notification as a return deadline notification, wherein the return deadline notification includes one or more of a product name, a serial number, a model number, a part number, a manufacturer name, a retailer name, a purchasing location, a purchasing location contact information, and a return deadline.
